(19) United States
(12) Patent Application Publication
(10) Pub. No.: US 2026/0075065 A1
(43) Pub. Date: Mar. 12, 2026

(54) Malicious network beaconing detection

(71) Applicant: Zscaler, Inc., San Jose, CA (US)

(72) Inventors: Zicun Cong, Burnaby (CA); Atinderpal Singh, Burnaby (CA); Pradeep Mahato, Bangalore (IN); Yung-Wen Lan, San Jose, CA (US); Kruti Sandeep Chauhan, Bangalore (IN); Dan Shacham, Kfar Kish (IL); Sandeep Paul, Bangalore (IN); Rex Shang, San Jose (CA); Deepen Desai, San Jose (CA); Jacob Bollinger, San Jose (CA)

(73) Assignee: Zscaler, Inc., San Jose, CA (US)

(21) Appl. No.: 18/925,429

(22) Filed: Oct. 24, 2024

(30) Foreign Application Priority Data
Sep. 11, 2024 (IN) 202441068738

(51) Int. Cl. H04L 9/40

(52) U.S. Cl. CPC H04L 63/1416; H04L 63/1425

(57) ABSTRACT

Systems and methods for malicious beaconing detection include extracting one or more beaconing sequences from log data associated with a network; performing feature extraction for the one or more extracted beaconing sequences; and implementing one or more Machine Learning (ML) models for classifying each of the one or more beaconing sequences as any of clean, malicious, suspicious, and unknown. The one or more ML models can be associated with an ensemble model, where a final classification of a beaconing sequence can be based on results of each of the one or more ML models.

### FIELD OF THE DISCLOSURE

The present disclosure generally relates to network and cloud security. More particularly, the present disclosure relates to systems and methods for malicious network beaconing detection.

### BACKGROUND OF THE DISCLOSURE

Malicious beaconing in networks refers to the covert communication between malware or compromised devices within a network and an external command and control server controlled by attackers. This communication is often used to exfiltrate data, receive instructions, or deliver additional payloads. Malicious beaconing poses significant security threats as it can facilitate various cyberattacks, including data breaches, espionage, and network disruption. Malicious beaconing is a sophisticated technique used by cyber attackers to maintain covert communication channels within compromised networks. Effective detection and mitigation require a combination of advanced monitoring, behavioral analysis, and proactive security measures. Understanding and addressing the threat of malicious beaconing is crucial for protecting network integrity and data security. Based thereon, the present systems and methods introduce advanced malicious beaconing detection processes for identifying and alerting to malicious beaconing within networks.

### BRIEF SUMMARY OF THE DISCLOSURE

The present disclosure relates to systems and methods for malicious network beaconing detection. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include extracting one or more beaconing sequences from log data associated with a network; performing feature extraction for the one or more extracted beaconing sequences; and implementing one or more Machine Learning (ML) models for classifying each of the one or more beaconing sequences as any of clean, malicious, suspicious, and unknown.

The steps can further include wherein the extracting includes distinguish beaconing activities from generic webpage loading activities within the log data based on one or more assumptions. The one or more assumptions can include whether a same Uniform Resource Locator (URL) is used within a sequence, whether a sequence includes a same request method for each transaction within the sequence, and whether a sequence includes a same response code for each transaction within the sequence. The one or more ML models can be associated with an ensemble model. The one or more ML models can be associated with an ensemble model, wherein the classifying is based on a weighted vote of the one or more ML models. The one or more ML models can be sub models associated with an ensemble model, wherein the classifying is based on weighing votes of each sub model based on each of the sub model's accuracy. The steps can further include classifying the one or more sequences as one of clean or other; and performing further examination on sequences of the one or more sequences classified as other for classifying each of the sequences as any of malicious, suspicious, and unknown. The extracting can include predicting a sequence of the one or more sequences includes beaconing activity based on a plurality of metric thresholds and performing feature extraction and classification of sequences comprising beaconing activity based thereon. The plurality of metrics can include a total number of transactions within the sequence, an average and standard deviation request size within the sequence, an average and standard deviation response size within the sequence, an average and standard deviation of time deltas between two consecutive log entries within the sequence, and a time span of the sequence. The steps can further include blocking transactions associated with a Uniform Resource Locator (URL) based on the URL being associated with a beaconing sequence classified as malicious.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flow diagram of the present process for malicious beaconing detection.

FIG. 6 is a flow diagram showing a training workflow for the present malicious beaconing detection models.

FIG. 7 is a flow diagram representing the workflow of the present malicious beaconing detection.

FIG. 8 is a flowchart of a process for malicious beaconing detection.

### DETAILED DESCRIPTION OF THE DISCLOSURE

Again, the present disclosure relates to systems and methods for malicious network beaconing detection. In various embodiments, processes are introduced to be facilitated via a cloud-based system for detecting beaconing activities within organizations networks. Various steps include extracting, from network log data, sequences of transactions that are determined to be beaconing sequences. Based thereon, one or more Machine Learning (ML) models can be utilized to make predictions as to whether the detected beaconing sequences are any of clean, malicious, suspicious, and unknown. By performing the malicious beaconing detection described herein, the cloud-based system can be adapted to provide alerts to network administrators and block traffic based on malicious beaconing classifications.

### § 1.0 Cybersecurity Monitoring and Protection Examples

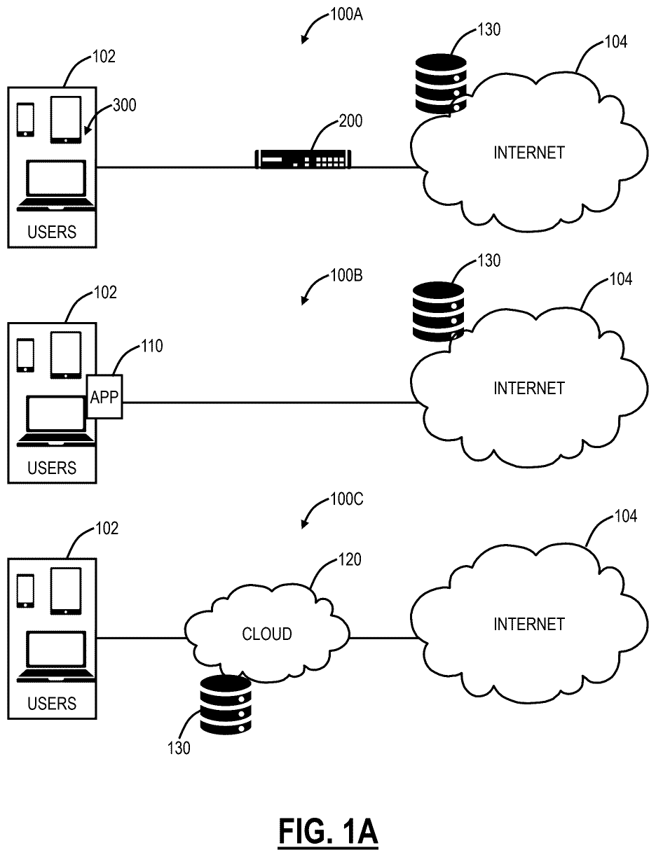

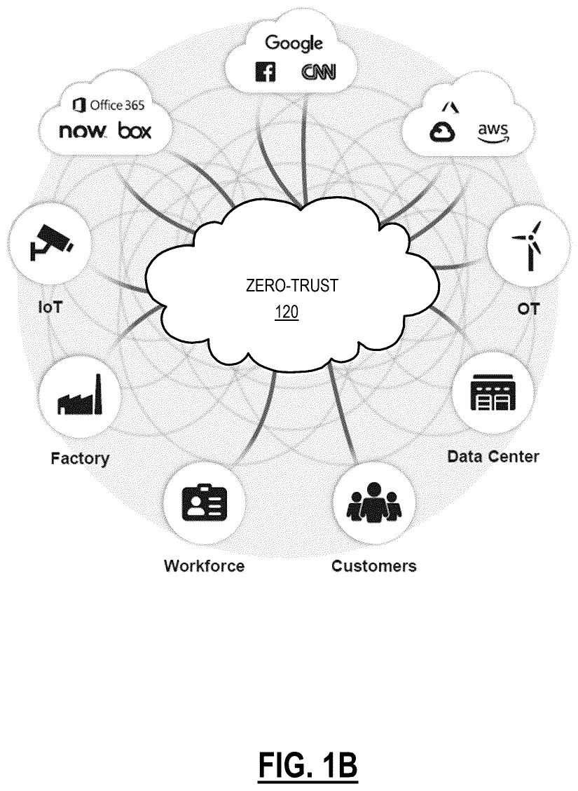

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

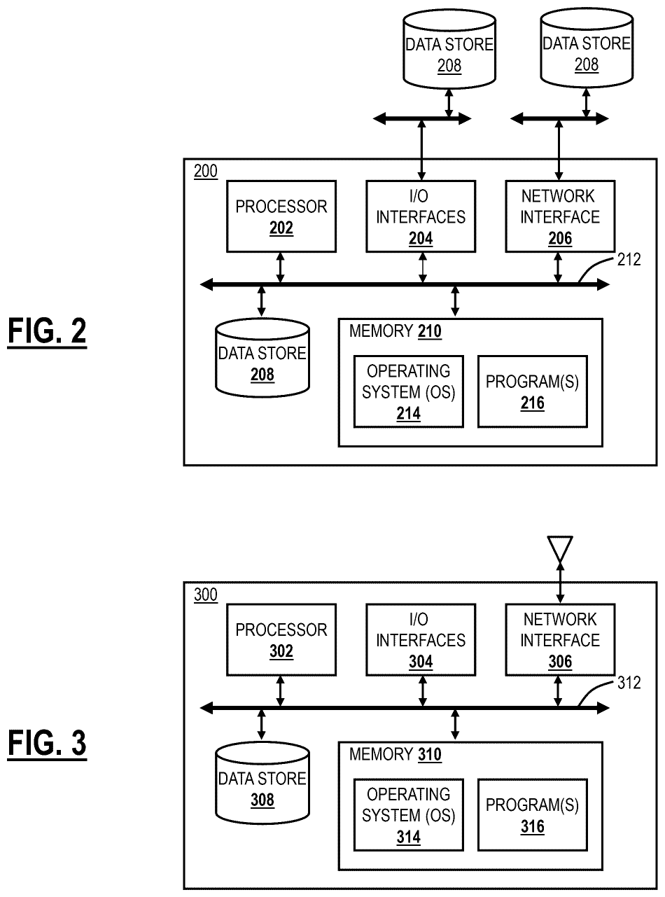

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time-before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IOT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

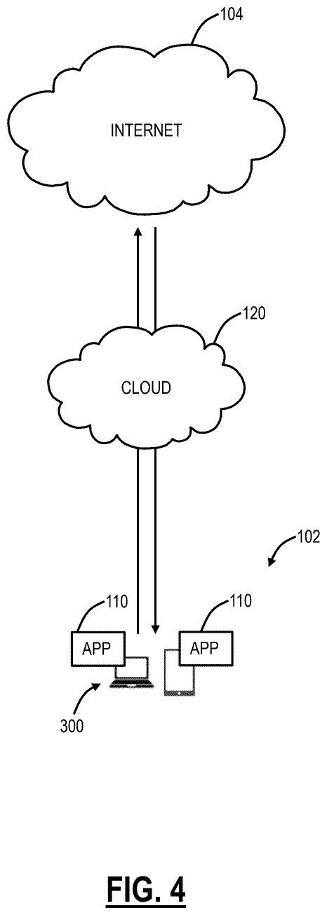

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 Malicious Beaconing Detection

The present disclosure relates to malicious network beaconing detection. That is, the present systems and methods provide malicious beaconing detection for traffic associated with any of the network configurations 100A, 100B, and 100C. The systems and methods described herein can be performed by the cloud 120, via any of the components of the cloud 120 such as servers 200, virtual machines, nodes, etc. Network beaconing is integral to both legitimate network operations and the landscape of cybersecurity threats. Fundamentally, a network beacon is a consistent and periodic transmission from a networked device or application that signals its status or presence. This process is akin to a heartbeat signal, a continuous pulse that assists in monitoring and managing network activities.

In legitimate operations, network beacons serve several essential purposes. They help maintain the synchronization of devices within a network, ensuring that all connected components are functioning correctly and efficiently. Beacons are used in various applications such as network management systems, where they facilitate the detection of device availability and operational status. For instance, in wireless networks, beacon frames are sent by access points to announce their presence and provide essential information to connected devices, aiding in the seamless connectivity and mobility of users. However, network beaconing can also be manipulated in cybersecurity threats. Malicious actors may use beacon signals to identify and map out network structures, preparing for more sophisticated attacks. These beacons can be part of a command and control (C2) framework used by malware to communicate with an attacker's server, enabling the exfiltration of data or the reception of further instructions. The regular and predictable nature of beaconing makes it a valuable tool for threat actors to maintain persistent access to compromised networks.

The dual nature of network beaconing highlights the importance of robust network security measures. Effective monitoring and analysis of beacon signals can help detect anomalies and potential threats, allowing for timely intervention. Network administrators must balance the need for legitimate beaconing to support network operations with the vigilance required to mitigate the risks posed by malicious beaconing activities. By leveraging the advanced security tools described herein, it is possible to enhance the resilience of networks against both operational disruptions and cybersecurity threats.

Again, in legitimate contexts, network beacons are used for routine operations that ensure smooth network functionality. Many wireless systems utilize beacon frames to manage connections and maintain network synchronization. These frames can contain information that clients use to adjust to the proper settings for communication. Additionally, applications often send out beacons to fetch instructions or send telemetry data. This is essential for services that rely on real-time data updates or for those that operate based on commands received from a centralized server. Although, as described, Malware often leverages beaconing to establish a line of communication with an attacker's command and control server. This periodic “calling home” is used to receive new instructions, exfiltrate data, or signal its active status.

Considering a situation where a user sends and receives data to and from a specific hostname through many network interactions. Beaconing activities can be characterized by regular, timed communication intervals. Based thereon, the present systems and methods are adapted to differentiate between benign and malicious network beaconing activities. In various embodiments, the present systems and methods are adapted to learn the patterns of command and control beaconing activities to reduce detection noise and provide accurate alerts.

In various embodiments, the present systems and methods leverage specific categories present in log data, such as within the log data 130. These categories can include, but are not limited to, MISCELLANEOUS_OR_UNKNOWN, NEWLY REGISTERED DOMAIN, MALICIOUS, PHISHING, BOTNET, and DLL/EXE downloading logs in the networks database/log data 130.

Further, the systems and methods can utilize logs from a particular user to a particular host name. These logs can be structured as a sequence of network transactions from a user to a host name. In an example, the following sequence represents an ordered sequence of network log entries recording the network traffic between a user U and a public non-malicious hostname H.

$${L}_{U ↔ H} = 〈 {l}_{1} , {l}_{2} , {l}_{3} , {l}_{4} , … , {l}_{n} 〉$$

Iᵢ is the i-th entry of the log sequence. A log entry xᵢ is a feature vector recording the properties of the request sending from U to H, and the properties of the corresponding response. The present objective is to develop a multi-class classifier f(L(U↔H)) to predict if the given log sequence L(U↔H) belongs to one of the following four categories, (1) Malicious; (2) Suspicious; (3) Unknown; and (4) Clean. Please note that URL H only contains the hostname and the URL path, that is, the query parameters of a URL is not included in H.

In various embodiments, to simplify the present implementation, a plurality of assumptions can be made for extracting beaconing sequences from the log data 130 for classification. The following three assumptions can be made to distinguish typical beaconing activities from generic webpage loading activities. These assumptions help to eliminate a large portion of false positives and simplify the modeling process.

Assumption 1: A beaconing sequence includes the same URL.

Assumption 2: A beaconing sequence includes the same request method.

Assumption 3: A beaconing sequence includes the same response code.

The following table includes a plurality of potential beaconing activities.

| | User | | Response | |
|---|---|---|---|---|
| Time | ID | Request | Code | URL |
| 10:11 | 123 | get | 200 - OK | your-api-endpoint.com/create- |
| | | | | vulnerability |
| 10:12 | 123 | get | 200 - OK | your-api-endpoint.com/create- |
| | | | | vulnerability |
| 10:14 | 123 | get | 200 - OK | your-api-endpoint.com/create- |
| | | | | vulnerability |
| 10:15 | 123 | get | 200 - OK | your-api-endpoint.com/create- |
| | | | | vulnerability |

As can be seen in the example table above, the sequence shown would be considered a beaconing sequence because each transaction includes the same URL, the same request method, and the same response code.

In various embodiments, each log entry Iᵢ in the log sequence L(U↔H) includes the following attributes.

| Name | Note |
|---|---|
| time | Transaction property |
| url | Transaction property |
| request | Transaction property |
| response | Transaction property |
| useragent | Transaction property |
| reqsize | Transaction property |
| respsize | Transaction property |
| reqhdrsize | Transaction property |
| resphdrsize | Transaction property |
| filetype | Transaction property |
| filename | Transaction property |
| serverip | Transaction property |
| refurl | Transaction property |
| protocolname | Transaction property |
| contenttype | Transaction property |
| urlcategoryname | labeled information |
| policy | labeled information |
| application | labeled information |
| app_risk_score | labeled information |
| malwareclass | labeled information |
| mobile_app | labeled information |
| mobile_appcategory | labeled information |
| appclass | labeled information |
| userid | User identifier |
| deviceid | User identifier |
| companyid | User identifier |
| clodname | User identifier |
| departmentid | User identifier |
| mobile_device | User identifier |

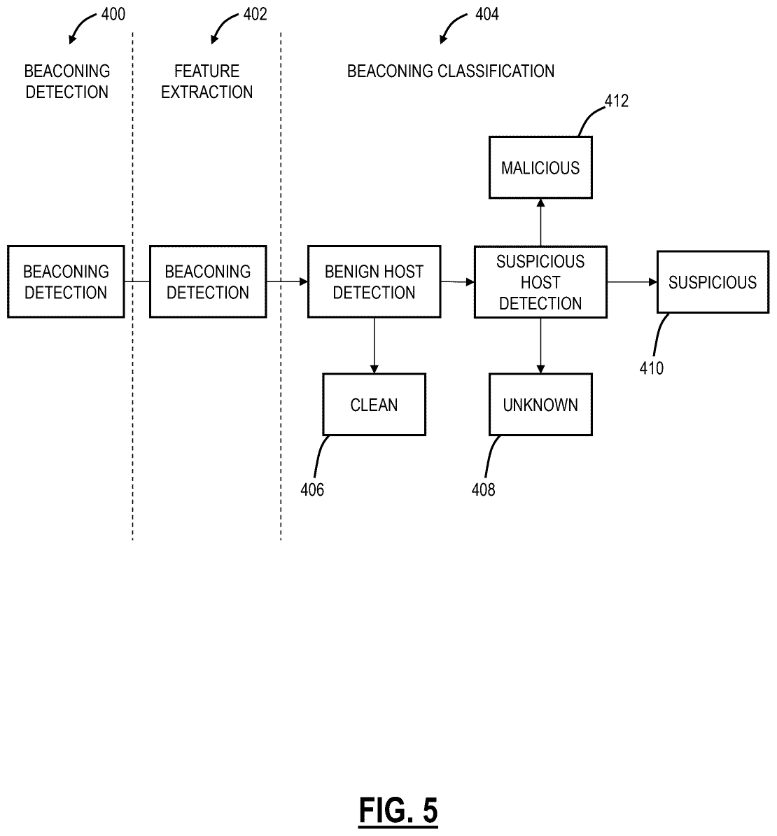

In various embodiments, the present process includes a three step solution. FIG. 5 is a flow diagram of the present process for malicious beaconing detection. The three steps include beaconing detection 400 feature extraction 402, and beaconing classification 404. During the beaconing detection 400 stage, the systems implement a heuristic model to identify beaconing activities in the log data 130 as described above. This is performed to eliminate host names that do not experience any beaconing activity. The various details associated with the heuristic model are further described herein. In a second step, given that a host name demonstrates beaconing activity, feature extraction 402 is performed, the extracted features being used in a third step of beaconing classification 404. For the beaconing classification 404 stage, an ensemble model is utilized. This model first separates the data into two categories: clean 406 and other. This initial classification helps to identify clearly benign activities. Sequences denoted as “other” by the first model will then be further examined to be classified as any of malicious 412, suspicious 410, and unknown 408. That is, any remaining, potentially suspicious activities are then examined more closely by a second model. This approach is used because data typically contains significantly more clean activities (over 1000 times more) than malicious activities, which makes training a single model for all categories of clean 406, unknown 408, suspicious 410, and malicious 412 challenging due to the imbalance. Further, after classification by one of the various models, based on a sequences classification, it will be placed into a specific database. That is, sequences classified as clean 406 are placed into a low risk database, sequences classified as unknown 408 are placed into an unknown database, sequences classified as suspicious 410 are placed into a suspicious database, and sequences classified as malicious 412 are placed into a malicious database.

Again, a heuristic beaconing detection model is utilized as a pre-filter component in the beaconing detection stage 400 for identifying sequences that represent beaconing as described herein. In order to make a determination as to if a host name demonstrates beaconing activity, various metrics/features are relied upon. In an example, the log sequence L(U↔H) records all the transactions a user U has with a specific URL H within a one-hour period from the start to the end of that hour. It will be appreciated that any other period of time is also contemplated for extracting traffic sequences between users and URLs. The following features are computed based on the data points in L(U↔H) to determine if beaconing is demonstrated.

Total number of transactions.

The average and standard deviation request size after removing outlying points.

The average and standard deviation response size after removing outlying points.

The average and standard deviation of the time delta between two consecutive log entries after removing outlying points.

The beaconing time span.

After computing these features for a given log sequence, the log sequence L(U↔H) is predicted as being beaconing traffic if the features meet the following criteria based on the following thresholds “t”.

Total number of transactions>tₜₓ

The standard deviation of the request size<t_{reqstd}

The standard deviation of the response size<t_{respstd}

The standard deviation of the time delta<t_{timestd}

The beaconing time span>tₜᵢₘₑₛₚₐₙ

As a beginning point, the thresholds for a log sequence being associated with beaconing traffic will start with tₜₓ=8, t_{respstd}=0.05, and t_{reqstd}=0.05. The numbers can be tuned in the future when more labeled data is available.

This pre-filtering process can be performed after the extraction of sequences from the log data 130 as described herein to further narrow down the plurality of sequences to be classified by the present models.

Once the pre-filtering, i.e., beaconing detection 400, is completed, only beaconing traffic is maintained, and feature extraction 402 can be performed for the one or more sequences that display beaconing activities. Various models for malicious beaconing detection are implemented as described in the beaconing classification 404 stage. The systems and methods implement an ensemble model Π to predict how likely a given log sequence L(U↔H) represents a malicious beaconing activity. In particular, ensemble model Π can be represented as follows.

$$Π = G ( {M}_{1} ( E ( {L}_{U ↔ H} ) ) , … , {M}_{m} ( E ( {L}_{U ↔ H} ) ) )$$

Where G is an aggregation function, E is a feature extractor, and Mᵢ is the i-th sub model of the ensemble model. In various embodiments, each sub model Mᵢ can either be a Machine Learning (ML) model or a heuristic rule-based model. For rule-based models, the sub models can be a tabular model, where the model extracts a feature vector X=<x₁, . . . , x_{f}> from the given log sequence L(U↔H). The tabular sub model Mᵢ takes the extracted feature vector X and predicts if the given log sequence is malicious. Further, the sub models can be a sequential model, where the model extracts a sequence of feature vectors S=<x₁, . . . , xₙ> from the given log sequence L(U↔H), where Xᵢ is the feature vector extracted from the log entry Iᵢ ∈L(U↔H). The ensemble function integrates outputs from the multiple sub models to enhance predictive accuracy and robustness against network transaction fraud.

In various embodiments, ensemble techniques include voting mechanisms, where each sub model votes on the classification of a transaction and where the final decision is based on majority vote. Additionally, weighted voting includes weighing votes based on each sub model's accuracy, where the sum determines the final classification if it exceeds a specific threshold. Finally, stacking includes initial predictions from sub models that are input into a meta-model, which then makes the final decision. This model can learn to optimally combine sub model outputs.

The feature vector X can include various types of features, each available in two versions including global and local. The global version uses data from all users, while the local version uses data from just the user being analyzed. A complete list of features that are utilized by the various sub models to make predictions can include the following feature types.

| Feature Type | Note |
|---|---|
| Hostname/ | This describes attributes of the URL's hostname, such as its |
| Domain Feature | popularity, complexity (entropy), and the number of subdomains. |
| URL Feature | This focuses on attributes of the URL itself. For example, it checks if |
| | the URL has been present in the network before, is new to the |
| | networks data, its complexity, and if it shares paths with known |
| | malicious URLs. |
| UserAgent | Based on analyzing users, this captures details about the browser |
| Feature | or tool the user accessed the URL with. For example, it includes |
| | checks for whether this tool was used by the user before and if it is |
| | related to an outdated operating system. |
| User-URL | This looks at the user's interaction with the URL, such as visiting the |
| Context Feature | same URL path from different hostnames during the same period of |
| | the beaconing activity/sequence, or downloading suspicious files |
| | beforehand. |
| RefURL Feature | This tracks features of the referral URL in the log sequence, |
| | including how often it appears and its popularity. |
| User Feature | This includes information about the user, such as their industry, |
| | company size, and device type associated with the user. |

Again, a heuristic model to label the obviously low risk beaconing hostnames are introduced. Further analyses are performed on hostnames that do not achieve the “clean” label. Based on the further analysis, each hostname is classified as one of the following three classes, including unknown beaconing, suspicious beaconing, and malicious beaconing, and placed into respective databases as described herein.

In various embodiments, the beaconing traffic classification can be performed by a plurality of sub models as described. These models can include tree models such as LightGBM and CatBoost, AutoML models such as AutoGluon, Large Language Models (LLMs) such as TabLLM for few-shot classification of tabular data with LLMs, and transformer models such as TuneTables and TabPNF.

### § 5.1 Model Training

In cybersecurity, datasets are typically highly imbalanced, with benign instances significantly outnumbering malicious ones. Even though the present systems and methods have already used heuristic rules to eliminate a large portion of possible benign transactions, the remaining data is still highly imbalanced. This imbalance can bias the machine learning model towards predicting the majority class, resulting in a high number of false negatives. Various techniques for handling such issues include Random Under-Sampling (RUS), Condensed Nearest Neighbor (CNN), One-sided Selection (OSS), Synthetic Minority Over-Sampling Technique (SMOTE), Selective Preprocessing of Imbalanced Data (SPIDER), ADAptive SYNthetic sampling (ADASYN), and removing obvious benign traffic with predefined rulesets. The RUS method balances class distribution by randomly eliminating majority class examples until the desired class ratio is achieved. Stratified sampling is applied. The system first clusters the negative data point. Then, k data points are sampled from each cluster. CNN discards instances that can be correctly classified by a model built on the current subset, refining the training data over successive iterations. OSS removes unreliable samples using heuristics, categorizing them into class-label noise, borderline examples, redundant samples, and safe samples. It retains all minority class samples and safe samples from the majority class. SMOTE generates synthetic samples by interpolating between minority class nearest neighbors. This method varies the interpolation based on random coefficients to diversify the synthetic samples. SPIDER oversamples misclassified minority class instances while filtering out challenging majority class examples, aiming to enhance classifier performance on imbalanced datasets. ADASYN adjusts the generation of synthetic samples based on the learning difficulty of minority class examples, producing more samples for those that are harder to classify. Finally, a predefined rule-set can be used to filter out obvious benign traffic from the training data. This reduces the instances of the majority class, helping to alleviate the data imbalance.

When building an ML model, the dataset is split into training, validation, and testing datasets. This can be done via time-based splitting or random sampling. For time-based sampling, the advantages include realism, mimicking real-world scenarios where models are trained on past data and used to make predictions about future events. It also prevents leakage ensuring that future data does not influence the model's performance on past data, preserving the causal direction of prediction. Various limitations of time-based approaches include the inability to use latest data for training and non-statutory issues. That is, this method cannot use the most recent data for training, which may result in models that are outdated by the time they are deployed. Further, If the data characteristics change over time (non-stationary data), the model trained on older data might perform poorly on newer data.

Similarly, random sampling also introduces various advantages and disadvantages. Advantages include maximized data utilization, allowing the model to learn from the entire dataset, potentially leading to better generalization on unseen data. This method is beneficial when the dataset is small and every data point counts for training the model effectively. Disadvantages include unrealistic scenarios and risk of leakage. These methods do not reflect a realistic operational scenario, especially for time-sensitive models. Using future data to predict past outcomes is not practical and can introduce unrealistic predictive power. Further, there is a significant risk that future data might leak into the training process, giving the model an unfair advantage and potentially skewing performance metrics.

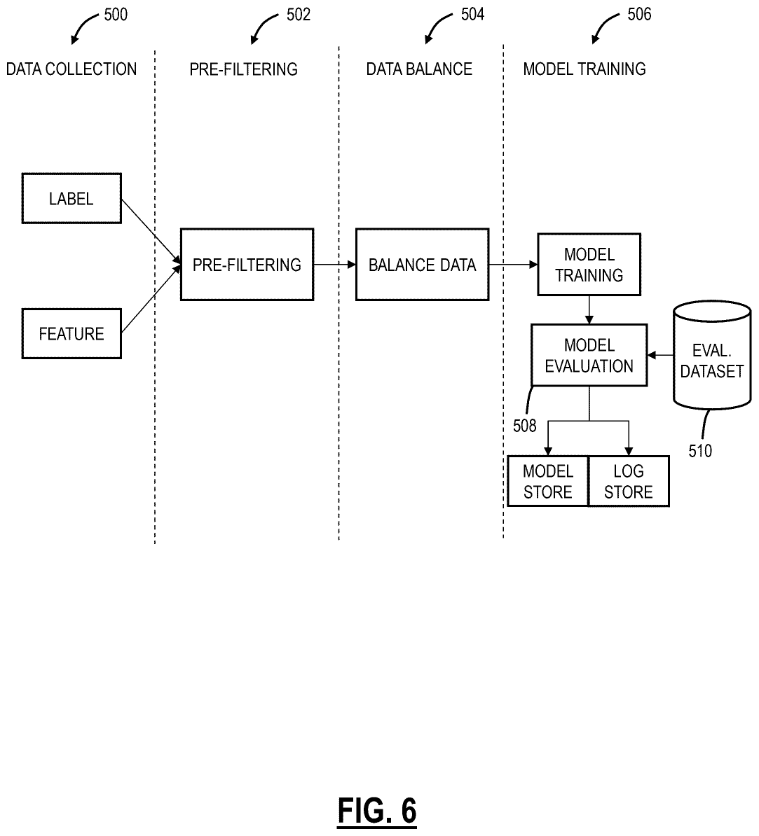

FIG. 6 is a flow diagram showing a training workflow for the present malicious beaconing detection models. In a first training stage, data collection 500 is performed. The data collection 500 includes obtaining labels and features associated with log data 130. In various embodiments, positive labels are collected from the log data 130 and reviewed by security researchers to remove label noise. Once the data is collected, a pre-filtering stage 502 is performed for removing obviously benign samples, i.e., removing obviously clean hostnames. This again helps to reduce the amount of training data as well as helping to balance the data as described above by removing obviously clean hostnames. Once the pre-filtering stage 502 is complete, the systems can implement a data balance stage 504. Again, the systems can implement any of the described methods for balancing the data. In addition to the described methods, the data balance stage 504 can include down sampling, up sampling, and synthetic data generation for balancing the data. after creating a balanced training dataset, the model training stage 506 can be initiated. Once a trained model is generated, the systems preform model evaluation 508 by feeding the trained model one or more evaluation datasets 510. Based on the trained model meeting specific criteria, the model will be saved for future use. Further the log can be saved for future training process debugging procedures.

In various embodiments, a debugging process can include various steps including the following.

Identification of misclassified instances: Initially, the process includes identifying instances misclassified by a model, focusing specifically on false positives (FP) and false negatives (FN). These errors could stem from the model's overfitting or underfitting to the training data.

Investigation of influential trees: For each misclassified instance, the process aims to pinpoint the most influential tree within the model that contributed to its decision. In this ensemble method, the final prediction for an instance is the sum of all trees' predictions. By identifying the tree with the largest vote and examining its branches, the process can trace the sequence of decisions based on features that led to the erroneous classification. Empirically, the process focuses on the tree with the largest vote to streamline this investigation.

Feature analysis: Analyzing the features leading to misclassification helps us understand the root causes of the model's errors. This analysis can reveal whether the model is giving undue importance to certain features, resulting in incorrect decisions.

Comparative analysis with training data: To further elucidate the model's behavior, the process includes identifying training data instances that fall within the influential branch causing the misclassification. Comparing these training instances with the misclassified test instance provides valuable insights. For example, if a false positive results from the model overfitting to positive labels, we might observe that the training data within that branch is predominantly positive.

Model adjustment: Based on the insights from the previous steps, the process allows adjustments to be made to the model. For instance, if the model overfits to positive labels within a specific branch, causing false positives, we can introduce more negative examples into that branch. This helps balance the training data and reduces overfitting, thereby improving the model's performance.

### § 5.2 Implementation

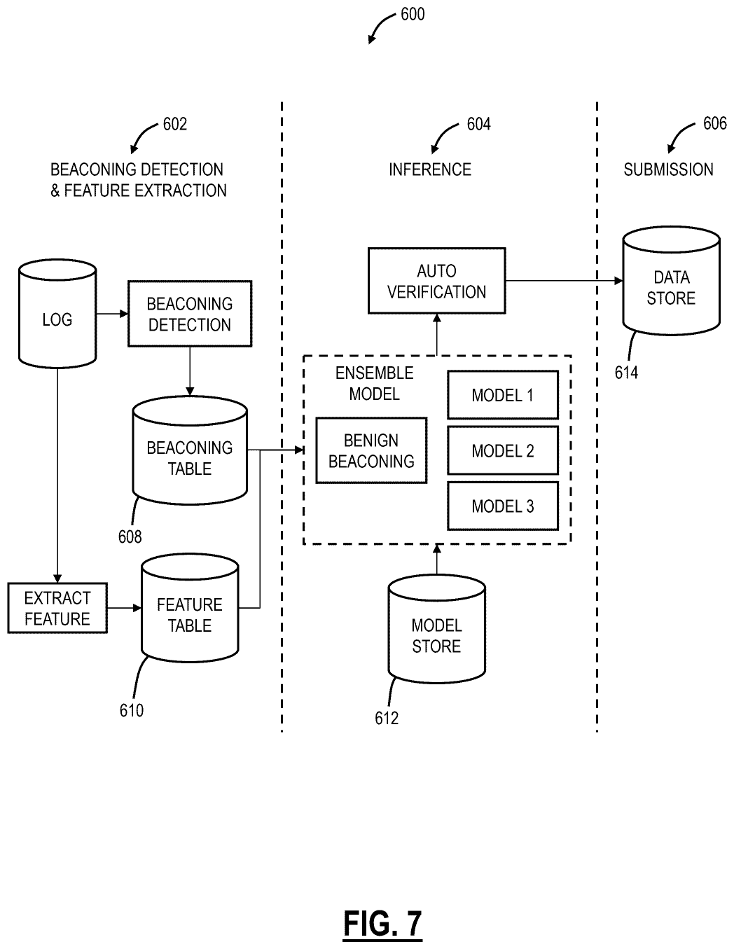

FIG. 7 is a flow diagram representing the workflow of the present malicious beaconing detection. In various embodiments, the workflow 600 is adapted to be executed on a daily schedule, or any other time period. During the beaconing detection and feature extraction stage 602, log data is retrieved from various cybersecurity services offered by the cloud 120 as described herein and from the log data 130. The becoming pre-filtering process is also initiated to identify potential beaconing sequences L(U↔H) as described herein. These potential beaconing sequences are stored in a beaconing table 608. Further, features are extracted to build feature vectors. The feature vectors are stored in a feature table 610.

During the inference stage 604, to focus on potentially threatening transactions, the systems and methods apply a heuristic rule to filter and retain only those transactions that exhibit suspicious characteristics. Heuristic rules for the purpose are listed below. The beaconing sequences that meet the criteria will be kept and fed into further analysis stages. The prediction results are then persisted in a table. This is done by first loading one or more models from a model store 612. The systems and methods then classify the feature vectors of each suspicious log sequence into one of the three labels, ‘unknown_beacon’, ‘suspicious_beacon’, and ‘malicious_beacon’ via one or more sub models as described herein. Any remaining transactions are directly put into the table with the ‘unknown_beacon’ label.

For the submission stage 606, the labeled sequences, after performing one of the various ensemble techniques described herein, are placed in a data store 614. Based thereon, alerts can be raised to administrators of organizations associated with the network for remedial action. Further, after classification, host names that pass an auto verification process can be automatically blocked by the present systems and methods. That is, host names associated with malicious beaconing can be blocked.

As described, the classification and label assignment for sequences can be performed by various heuristic models of the ensemble model. For detecting clean, malicious, unknown, and suspicious beaconing activities, the following heuristic model rules are proposed.

| Label | Rules | |
|---|---|---|
| Clean | Rules for deciding if a beaconing sequence is Clean: | |
| | 1. | Is the domain/hostname within an allowlist? |

| | |
|---|---|
| a. | Top-1000 on Alexa |
| b. | Top-1000 on cloudflare |
| c. | Internal allowlist |

| | |
|---|---|
| 2. | Is the user agent within an allowlist? |
| 3. | URL with known favicon |
| 4. | Host path is more than 90 days old and the user agent is also old to |
| | the user. The host path age referring to the length of time a URL |
| | has been seen in the network. Similarly, user agent age being |
| | associated with the length of time a user has been using a particular |
| | user agent. |

| | |
|---|---|
| a. | As long as there is one user who meets the criteria, the URL |
| | is flagged as clean |
| b. | Computed across all data, beyond beaconing |

| | |
|---|---|
| 5. | Host path and host name popularity |

| | |
|---|---|
| a. | Hostname seen for more than 100 companies or a particular |
| | URL seen for more than 60 companies |

| Malicious | Rules for deciding if a beaconing sequence is Malicious: | |
|---|---|---|
| | 1. | Silver/Mythic/Cobalt Strike rules |
| | 2. | URL category is malicious |
| | 3. | The hostname in a database with malicious, botnet, or phishing |
| | | category |
| | With utilization of an ML model, the sequence is classified as Malicious | |
| | when the ML model confidence is high based on a threshold. | |
| Suspicious | Rules for deciding if a beaconing sequence is Suspicious: | |
| | 1. | Hostnames with positive predictions from the Cobalt Strike model |
| | With utilization of an ML model, the sequence is classified as Suspicious | |
| | when the ML model confidence is below the threshold of malicious. | |
| Unknown | Rules for deciding if a beaconing sequence is Unknown: | |
| | 1. | Anything that does not fall into the above three categories |
| | 2. | Transaction count is greater than or equal to 100 |
| | 3. | The time span is greater than a threshold |

For many types of malware, there isn't enough data available to build machine learning models. In these situations, the systems leverage rule-based models instead. Various methods have been developed for Mythic and Sliver malware by working closely with security researchers.

Malware

| Type | Rules | |
|---|---|---|
| Mythic | Mythic detection model is based on following two ruleset | |
| | Ruleset 1 | |
| | 1. | We select the mythic hostnames having /data or /form signature, post |
| | | request with 200 - OK response |
| | 2. | For those selected hostnames, we check for the presence of |
| | | “index?q=” in url and ‘%Trident%’ in useragent with ‘200 - OK’ get |
| | | response and request size is equal to request header size |
| | Ruleset 2 | |
| | 1. | We select hostnames with /data or /form suffix and ‘%Trident%’ in |
| | | useragent as post request with 200 - OK response. |
| | 2. | For the above hostnames we select if these hostnames have |
| | | beaconing activity, by checking if the coefficient of variation of |
| | | request size/response size is less than 10. |
| Sliver | Sliver detection model is based on the presence of many signals. | |
| | They are | |
| | 1. | Presence of no refurl |
| | 2. | Presence of following URL sequence |

| | |
|---|---|
| a. | GET transaction and url ends with .woff |
| b. | GET transaction and url ends with .html |
| c. | GET transaction and url ends with .js |
| d. | POST transaction and url ends with .php |

| 3. | We select hostnames if atleast one sequence is present, woff->html, |
|---|---|
| | html->js or js->php |
| 4. | Each URL has an argument pattern like ?[a-z_]{1, 3} = ([a-z_]?\d[a- |
| | z_]?){8, 16}$. The key length should be between 1, 3 characters |
| | including underscore and the value comprises alphanumeric |
| | characters with length between 8, 16. After removing the alphabets |
| | from values, it should contains only digits with length between 8, 12 |
| 5. | URL ending with HTML, should have 2 key-value argument pair and |
| | others only 1 key-value argument pair |
| 6. | The argument values should not be repeated. |
| 7. | URL ending with JS type may contain “204 - No content” response |
| 8. | URL ending with PHP type and POST requests may contains “202 - |
| | Accepted” response |
| In addition to the above rules, the current sliver detection model uses | |
| following rules | |
| 1. | We select hostnames having at least 1 txs with 204 or 202 response |
| 2. | And having at least 1 txs with matching PHP and HTML url pattern |

To remove FP, we filtered out values which represents a data format like
20240114 or 01142024

Again, as described herein, the present steps of the various processes described herein for malicious beaconing detection can be performed via the various network configurations 100A, 100B, and 100C. That is, the malicious beaconing detection can be performed on a per-network bases by utilizing the log data 130 of a particular network. Further, as described, the steps can be facilitated by the cloud 120 and its various components for determining malicious beaconing activities within the networks.

### § 5.3 Process for Malicious Beaconing Detection

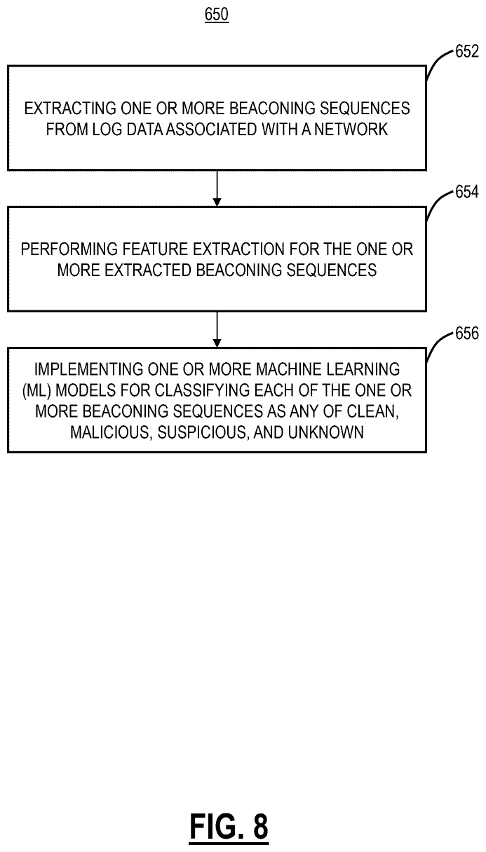

FIG. 8 is a flowchart of a process 650 for malicious beaconing detection. The process 650 can be implemented as a method having steps, a processing device configured to implement the steps, a cloud-based system configured to implement the steps, and as a non-transitory computer-readable medium storing instructions for programming one or more processors to execute the steps. The process 650 includes extracting one or more beaconing sequences from log data associated with a network (step 652); performing feature extraction for the one or more extracted beaconing sequences (step 654); and implementing one or more Machine Learning (ML) models for classifying each of the one or more beaconing sequences as any of clean, malicious, suspicious, and unknown (step 656).

The process 650 can further include wherein the extracting includes distinguish beaconing activities from generic webpage loading activities within the log data based on one or more assumptions. The one or more assumptions can include whether a same Uniform Resource Locator (URL) is used within a sequence, whether a sequence includes a same request method for each transaction within the sequence, and whether a sequence includes a same response code for each transaction within the sequence. The one or more ML models can be associated with an ensemble model. The one or more ML models can be associated with an ensemble model, wherein the classifying is based on a majority vote of the one or more ML models. The one or more ML models can be sub models associated with an ensemble model, wherein the classifying is based on weighing votes of each sub model based on each of the sub model's accuracy. The steps can further include classifying the one or more sequences as one of clean or other; and performing further examination on sequences of the one or more sequences classified as other for classifying each of the sequences as any of malicious, suspicious, and unknown. The extracting can include predicting a sequence of the one or more sequences includes beaconing activity based on a plurality of metric thresholds and performing feature extraction and classification of sequences comprising beaconing activity based thereon. The plurality of metrics can include a total number of transactions within the sequence, an average and standard deviation request size within the sequence, an average and standard deviation response size within the sequence, an average and standard deviation of time deltas between two consecutive log entries within the sequence, and a time span of the sequence. The steps can further include blocking transactions associated with a Uniform Resource Locator (URL) based on the URL being associated with a beaconing sequence classified as malicious.

### § 6.0 Conclusion

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A method comprising steps of:
extracting one or more beaconing sequences from log data associated with a network;
performing feature extraction for the one or more extracted beaconing sequences; and
implementing one or more Machine Learning (ML) models for classifying each of the one or more beaconing sequences as any of clean, malicious, suspicious, and unknown.

2. The method of claim 1, wherein the extracting comprises distinguish beaconing activities from generic webpage loading activities within the log data based on one or more assumptions.

3. The method of claim 2, wherein the one or more assumptions comprise whether a same Uniform Resource Locator (URL) is used within a sequence, whether a sequence includes a same request method for each transaction within the sequence, and whether a sequence includes a same response code for each transaction within the sequence.

4. The method of claim 1, wherein the one or more ML models are associated with an ensemble model.

5. The method of claim 1, wherein the one or more ML models are associated with an ensemble model, and wherein the classifying is based on a majority vote of the one or more ML models.

6. The method of claim 1, wherein the one or more ML models are sub models associated with an ensemble model, and wherein the classifying is based on weighing votes of each sub model based on each of the sub model's accuracy.

7. The method of claim 1, wherein the classifying comprises steps of:
classifying the one or more sequences as one of clean or other; and
performing further examination on sequences of the one or more sequences classified as other for classifying each of the sequences as any of malicious, suspicious, and unknown.

8. The method of claim 1, wherein the extracting comprises predicting a sequence of the one or more sequences comprises beaconing activity based on a plurality of metric thresholds and performing feature extraction and classification of sequences comprising beaconing activity based thereon.

9. The method of claim 8, wherein the plurality of metrics comprise a total number of transactions within the sequence, an average and standard deviation request size within the sequence, an average and standard deviation response size within the sequence, an average and standard deviation of time deltas between two consecutive log entries within the sequence, and a time span of the sequence.

10. The method of claim 1, wherein the steps further comprise blocking transactions associated with a Uniform Resource Locator (URL) based on the URL being associated with a beaconing sequence classified as malicious.

11. A non-transitory computer-readable medium comprising instructions that, when executed, cause one or more processors to perform steps of:
extracting one or more beaconing sequences from log data associated with a network;
performing feature extraction for the one or more extracted beaconing sequences; and
implementing one or more Machine Learning (ML) models for classifying each of the one or more beaconing sequences as any of clean, malicious, suspicious, and unknown.

12. The non-transitory computer-readable medium of claim 11, wherein the extracting comprises distinguish beaconing activities from generic webpage loading activities within the log data based on one or more assumptions.

13. The non-transitory computer-readable medium of claim 12, wherein the one or more assumptions comprise whether a same Uniform Resource Locator (URL) is used within a sequence, whether a sequence includes a same request method for each transaction within the sequence, and whether a sequence includes a same response code for each transaction within the sequence.

14. The non-transitory computer-readable medium of claim 11, wherein the one or more ML models are associated with an ensemble model.

15. The non-transitory computer-readable medium of claim 11, wherein the one or more ML models are associated with an ensemble model, and wherein the classifying is based on a majority vote of the one or more ML models.

16. The non-transitory computer-readable medium of claim 11, wherein the one or more ML models are sub models associated with an ensemble model, and wherein the classifying is based on weighing votes of each sub model based on each of the sub model's accuracy.

17. The non-transitory computer-readable medium of claim 11, wherein the classifying comprises steps of:
classifying the one or more sequences as one of clean or other; and
performing further examination on sequences of the one or more sequences classified as other for classifying each of the sequences as any of malicious, suspicious, and unknown.

18. The non-transitory computer-readable medium of claim 11, wherein the extracting comprises predicting a sequence of the one or more sequences comprises beaconing activity based on a plurality of metric thresholds and performing feature extraction and classification of sequences comprising beaconing activity based thereon.

19. The non-transitory computer-readable medium of claim 18, wherein the plurality of metrics comprise a total number of transactions within the sequence, an average and standard deviation request size within the sequence, an average and standard deviation response size within the sequence, an average and standard deviation of time deltas between two consecutive log entries within the sequence, and a time span of the sequence.

20. The non-transitory computer-readable medium of claim 11, wherein the steps further comprise blocking transactions associated with a Uniform Resource Locator (URL) based on the URL being associated with a beaconing sequence classified as malicious.
